(19) United States
(12) Patent Application Publication
(10) Pub. No.: US 2015/0118929 A1
(43) Pub. Date: Apr. 30, 2015

(54) SHEET-SHAPED ARTICLE AND PRODUCTION METHOD THEROF (AS AMENDED)

(71) Applicant: TORAY INDUSTRIES, INC., TOKYO (JP)

(72) Inventors: Shunichiro Nakai, Anpachi-gun (JP); Gen Koide, Otsu-shi (JP); Hisashi Murahara, Anpachi-gun (JP)

(73) Assignee: TORAY INDUSTRIES, INC., TOKYO (JP)

(21) Appl. No.: 14/398,874

(22) PCT Filed: May 1, 2013
(86) PCT No.: PCT/JP2013/062692

§ 371 Date: Nov. 4, 2014

(30) Foreign Application Priority Data
May 11, 2012 (JP) 2012-109182 2012

(51) Int. Cl. D06M 15/564; B05D 5/00

(52) U.S. Cl. CPC D06M 15/564; B05D 5/00
USPC 442/60; 427/212

(57) ABSTRACT

The present invention provides: a method for producing, by an eco-friendly production step, a sheet-form product that has an elegant napped appearance and that has excellent wear resistance and texture; and the sheet-form product. This sheet-form product includes a fibrous base material including ultrathin fibers with an average monofilament diameter of 0.3 to 7 [mu]m; and a water-dispersible polyurethane contained inside the fibrous base material, the water-dispersible polyurethane including both a substance having a molecular weight of 100 to 500 and having an amide bond, and inorganic particles having an average particle diameter of 1 nm to 10,000 nm. Porous particles having a BET specific surface of 5 m2/g or greater are preferably used as said inorganic particles.

### CROSS REFERENCE TO RELATED APPLICATIONS

This is the U.S. National Phase application of PCT/JP2013/062692, filed May 1, 2013, which claims priority to Japanese Patent Application No. 2012-109182, filed May 11, 2012, the disclosures of each of these applications being incorporated herein by reference in their entireties for all purposes.

### FIELD OF THE INVENTION

The invention relates to an environmentally friendly manufacture method for a sheet-shaped article that does not use an organic solvent in the manufacture process and to a sheet-shaped article, and particularly relates to a sheet-shaped article that is good in surface quality and texture and to a manufacture method for the article.

### BACKGROUND OF THE INVENTION

Sheet-shaped articles made up mainly of a fibrous base material and polyurethane have excellent features that natural leathers do not have, and are widely utilized in various uses. In particular, a sheet-shaped article that employs a polyester-based fibrous base material is excellent in light resistance, and therefore its use has spread year by year to clothing, chair upholstery, automotive interior finishing material uses, etc.

To produce such a sheet-shaped article, a combination of processes in which a fibrous base material is impregnated with an organic solvent solution of polyurethane, and then the obtained fibrous base material is dipped in an organic solvent aqueous solution or water that is a non-dissolving medium for polyurethane, so as to cause polyurethane to undergo wet coagulation is generally adopted.

As the organic solvent that is a dissolving medium for polyurethane used herein, a water-miscible organic solvent, such as N,N-dimethylformamide, is used. However, since organic solvents are generally high in harmfulness to the human body and the environment, the manufacture of a sheet-shaped article strongly requires a technique that does not use an organic solvent.

As a concrete solution means therefore, for example, a method that employs a water dispersed-type polyurethane obtained by dispersing polyurethane in water instead of a conventional organic solvent type of polyurethane is being considered. Here, there is an issue that, in a sheet-shaped article obtained by impregnating and providing a fibrous base material with water dispersed-type polyurethane, the texture is likely to become hard. As a main cause of it, it can be mentioned that polyurethane strongly holds intermingled portions of the fibrous base material, resolution of which has been considered.

That is, in order to restrain polyurethane from holding fiber interminglement points, a technology has been proposed in which the structure of polyurethane in the fibrous base material is made to be a porous structure.

Concretely, a full grain-like artificial leather obtained by adding thermally expansive capsules to water dispersed-type polyurethane and coating it on a fibrous base material has been proposed (refer to Patent document 1). However, in this proposal, a porous structure is made by causing the thermally expansive capsules in the polyurethane to expand, that is, the polyurethane in the fibrous base material can be caused to have a porous structure by impregnating and providing the fibrous base material with the thermally expansive capsules. However, this proposal has issues that thermal burn or color development results from the added thermally expansive capsules and that the hardness of the thermally expansive capsules themselves hardens the texture of the sheet-shaped article.

Furthermore, it has been proposed that the structure of polyurethane in a fibrous base material is made to be a porous structure by imparting to the fiber base material a water dispersed-type polyurethane liquid that contains a foaming agent and causing the foaming agent to foam by heating (refer to Patent document 2). In this proposal, because the polyurethane is made porous, the contact area between the fiber and the polyurethane decreases, and the holding force at the interminglement points of fiber weakens, so that a sheet-shaped article having a good texture with the feel being soft can be obtained. However, with this proposal, the combination of polyurethane and a foaming agent is limited; for instance, in the case where a polyurethane whose thermal coagulation temperature is high and a foaming agent whose foaming temperature is low are combined, bubbles formed by the foaming expand prior to the coagulation of the polyurethane, so that a porous structure of the polyurethane cannot be obtained.

Similarly, a method for manufacturing a porous resin by performing a heating process of a synthetic resin in the presence of a foaming agent has been proposed (refer to Patent document 3). However, similar to the aforementioned examples, this proposal is limited in the combination of a synthetic resin and a foaming agent, and thus is not necessarily a technology that is capable of providing a purposed porous structure.

### PATENT DOCUMENTS

Patent document 1: Japanese Unexamined Patent Publication (Kokai) No. 2004-339614
Patent document 2: Japanese Unexamined Patent Publication (Kokai) No. 2011-214210
Patent document 3: Japanese Unexamined Patent Publication (Kokai) No. 2011-116951

### SUMMARY OF THE INVENTION

Accordingly, an object of the invention is, in view of the aforementioned background of the conventional art, to provide a manufacturing method for a sheet-shaped article that has a graceful external appearance, good abrasion resistance and texture, due to a manufacturing process that is friendly to the environment, and provide that sheet-shaped article.

The invention is intended to accomplish the aforementioned problems, and the sheet-shaped article of the invention includes a sheet-shaped article containing a water dispersed-type polyurethane that contains both a substance whose molecular weight is 100 to 500 and which has an amide bond and an inorganic particle whose average particle size is 1 nm to 10,000 nm, within a fibrous base material that includes an ultrathin fiber whose average monofilament diameter is 0.3 to 7 μm.

According to a preferred mode of the sheet-shaped article of the invention, the inorganic particle is a porous particle whose BET specific surface area is greater than or equal to 5 m²/g.

According to a preferred mode of the sheet-shaped article of the invention, the inorganic particle is of silica.

Furthermore, an embodiment of the manufacturing method includes imparting to a fibrous base material a water dispersed-type polyurethane liquid that contains both a foaming agent and an inorganic particle and performing a heating process at a temperature that is greater than or equal to a temperature at which at least a portion of the foaming agent reacts and produces a gas.

According to a preferred mode of the manufacture method for the sheet-shaped article of the invention, the foaming agent is a water-soluble azo polymerization initiating agent, and the fibrous base material includes an ultrathin fiber development type fiber.

According to a preferred mode of the manufacture method for the sheet-shaped article of the invention, a process of developing from the ultrathin fiber development type fiber an ultrathin fiber whose average monofilament diameter is 0.3 to 7 μm is undergone.

According to the invention, due to the manufacture process that is friendly to the environment, a sheet-shaped article having a graceful external appearance and good abrasion resistance and texture can be obtained.

### DESCRIPTION OF EMBODIMENTS OF THE INVENTION

The sheet-shaped article of an embodiment of the invention is a sheet-shaped article containing a water dispersed-type polyurethane that contains both a substance whose molecular weight is 100 to 500 and which has an amide bond and an inorganic particle whose average particle size is 1 nm to 10,000 nm, within a fibrous base material that includes an ultrathin fiber whose average monofilament diameter is 0.3 to 7 μm.

As the fibrous base material for use in the invention, woven fabric, knitted fabric, non-woven fabric, etc. can be adopted. Among such, non-woven fabric is preferably used because the surface quality of the sheet-shaped article is good when the article is subjected to a surface nap raising process.

As the non-woven fabric, either short-fiber non-woven fabric or long-fiber non-woven fabric will do. However, in terms of texture and quality, short-fiber non-woven fabric is preferably used.

The fiber length of short fiber of the short-fiber non-woven fabric is preferably 25 mm to 90 mm. By having the fiber length greater than or equal to 25 mm, a sheet-shaped article excellent in abrasion resistance can be obtained by intertwinement. Furthermore, by having the fiber length less than or equal to 90 mm, and more preferably less than or equal to 80 mm, a sheet-shaped article more excellent in texture and quality can be obtained.

In the case where the fibrous base material is a non-woven fabric, it is a preferable mode that the non-woven fabric is one that has a structure that is formed by intertwinement of bundles (fiber bundles) of ultrathin fiber. Due to the intertwinement of ultrathin fiber in the state of bundles, the strength of the sheet-shaped article improves. This mode of non-woven fabric can be obtained by intertwining ultrathin fiber development type fiber beforehand and then developing ultrathin fiber.

As a method for intertwining fiber or fiber bundles in a non-woven fabric, needle punch or water jet punch can be adopted.

In the case where the fibrous base material is a non-woven fabric, it is a preferable mode to insert therein a woven fabric or a knitted fabric for the purpose of improving strength or the like.

As the fiber that constitutes the fibrous base material, it is possible to employ a fiber made up of a melt-spinnable thermoplastic resin such as polyesters, including polyethylene terephthalate, polybutylene terephthalate, polytrimethylene terephthalate, polylactic acid, etc., polyamides, including 6-nylon, 66-nylon, etc., acryl, polyethylene, polypropylene, thermoplastic cellulose, etc. Among such, a preferable mode is to use polyester fiber, from the viewpoint of strength, dimensional stability and light resistance. Furthermore, the fibrous base material may be composed of a mixture of fibers of difference materials.

The cross-sectional shape of the fiber constituting the fibrous base material may be a round section, and it is also possible to adopt a fiber whose section has an elliptical shape, a flat shape, a polygonal shape, such as a triangular shape, a less common shape, such as a fan shape or a cross shape.

Although the average monofilament diameter of the ultrathin fiber included in the fibrous base material is 0.3 to 7 μm, the fibrous base material in the invention can also contain a fiber whose average monofilament diameter is 0.3 to 25 μm within such a range that the effects of the invention are not impeded. If the average monofilament diameter of the fiber is less than or equal to 25 μm, and preferably less than or equal to 22 μm, and more preferably less than or equal to 20 μm, the feel of the fibrous base material becomes soft. On the other hand, if the average monofilament diameter of the fiber is greater than or equal to 0.3 μm, and preferably greater than or equal to 0.7 μm, and more preferably greater than or equal to 1 μm, the color development property after dyeing is excellent.

Furthermore, in the invention, the use of an ultrathin fiber development type fiber is a preferable mode. Because of using an ultrathin fiber development type fiber, it is possible to stably obtain a configuration in which bundles of ultrathin fiber of which the aforementioned average filament diameter is 0.3 to 7 μm are intertwined.

As the ultrathin fiber development type fiber, it is possible to adopt a sea-island fiber that is made up of two component thermoplastic resins different in solvent solubility as a sea component and an island component so that the island component will be left as ultrathin fiber by dissolving and removing the sea component through the use of a solvent or the like, a splittable conjugate fiber that has an arrangement in which two component thermoplastic resins are alternately arranged in a multilayer manner or in a radial manner in terms of fiber section so that the fiber will be separated into ultrathin fibers by splitting and separating the two components, etc. Among such, the sea-island fiber is preferably employed from the viewpoint of the softness and texture of the sheet-shaped article because, by removing the sea component, appropriate air spaces can be provided between the island component portions, that is, between the ultrathin fibers. The sea-island fiber includes a sea-island conjugate fiber formed by spinning two components, that is, a sea component and an island component, which are arrayed with each other by employing a sea-island conjugating nozzle, a mixed spun fiber formed by spinning a mixture of two components, that is, a sea component and an island component, etc. From the viewpoints that ultrathin fibers having a uniform degree of fineness are obtained and that sufficiently long ultrathin fibers are obtained, contributing to the strength of the sheet-shaped article, the sea-island conjugate fiber is preferably employed.

As the sea component of the sea-island fiber, it is possible to employ polyethylene, polypropylene, polystyrene, a copolymerized polyester obtained by copolymerizing sodium sulfoisophthalate, polyethylene glycol, etc., polylactic acid, etc. Among such, polylactic acid or a copolymerized polyester obtained by copolymerizing alkali-decomposable sodium sulfoisophthalate, polyethylene glycol, etc., which can be decomposed without using an organic solvent, is preferably employed.

As the island component of the sea-island fiber, it is possible to employ a melt-spinnable thermoplastic resin such as polyesters, including polyethylene terephthalate, polybutylene terephthalate, polytrimethylene terephthalate, polylactic acid, etc., polyamides, including 6-nylon 66-nylon, etc., acryl, polyethylene, polypropylene, thermoplastic cellulose, etc., which constitutes the fibrous base material as mentioned above. Among such, polyester is preferably employed.

The average monofilament diameter of the ultrathin fibers obtained from the island component of the sea-island fiber is 0.3 to 7 μm. By having the average monofilament diameter less than or equal to 7 μm, more preferably less than or equal to 6 μm, and even more preferably less than or equal to 5 μm, a sheet-shaped article excellent in softness and nap quality can be obtained. On the other hand, by having the average monofilament diameter greater than or equal to 0.3 μm, more preferably greater than or equal to 0.7 μm, and even more preferably greater than or equal to 1 μm, the sheet-shaped article will be excellent in the post-dyeing color development property, the dispersibility of bundled fibers at the time of the napping process, such as the grinding with sandpaper or the like, and the ease of separation.

A sea removal process in the case where a sea-island fiber is employed may be carried out before a water dispersed-type polyurethane is imparted to the fibrous base material, or may also be carried out after the impartation. If the sea removal process is carried out before the impartation of the water dispersed-type polyurethane, the abrasion resistance of the sheet-shaped article becomes good because a structure in which the water dispersed-type polyurethane directly adheres to the ultrathin fiber is formed so that the ultrathin fibers can be firmly held. On the other hand, if the sea removal process is carried out after the impartation of the water dispersed-type polyurethane, gas spaces form, resulting from the sea component being removed, between the water dispersed-type polyurethane and the ultrathin fibers, so that the ultrathin fibers are not directly held by the water dispersed-type polyurethane and the texture of the sheet-shaped article becomes soft.

The sea removal process can be carried out by dipping the fibrous base material that includes the sea-island fiber into a solvent and then squeezing the liquid. As the solvent that dissolves the sea component, an organic solvent, such as toluene or trichloroethylene, can be employed in the case where the sea component is polyethylene, polypropylene or polystyrene. Furthermore, in the case where the sea component is a copolymerized polyester or polylactic acid, an alkali solution, such as sodium hydroxide aqueous solution, can be employed as a solvent that dissolves the sea component.

A 100% modulus of a dry film of polyurethane that constitutes the water dispersed-type polyurethane liquid for use in the invention is preferably greater than or equal to 3 MPa and less than or equal to 8 MPa. The 100% modulus of the dry film of polyurethane is an index that represents the hardness of polyurethane. In the invention, because the 100% modulus is within this range, the structure of polyurethane within the polyurethane-imparted sheet-shaped article can be made to be a porous structure, so that good grindability is exhibited in the nap raising step with a sandpaper or the like, and therefore a graceful external appearance having a nap can be obtained. The 100% modulus of the dry film of the water dispersed-type polyurethane is more preferably greater than or equal to 3 MPa and less than or equal to 6 MPa. With the 100% modulus being within this range, the texture and the abrasion resistance of the polyurethane sheet-shaped article become good. The 100% modulus can be adjusted by the proportion of a hard segment structure resulting from a chain elongation agent or isocyanate within the polyurethane molecular structure, or the kinds of polyol, isocyanate, etc.

The polyurethane liquid for use in the invention is preferably a water dispersed-type polyurethane liquid dispersed and stabilized in water. The water dispersed-type polyurethane is sorted into a forcedly emulsified polyurethane that has been forced to disperse and stabilize by using a surface active agent, and a self-emulsified polyurethane that has a hydrophilic structure in a polyurethane molecular structure and that disperses and stabilizes in water even without the presence of a surface active agent. In the invention, either type of water dispersed-type polyurethane may be employed. However, in view of not containing a surface-active agent, the self-emulsified polyurethane is preferably employed. In the case where the forcedly emulsified polyurethane containing a surface active agent is employed, the surface active agent becomes a cause of occurrence of stickiness of the surface of the sheet-shaped article or the like, so that a washing process is needed and therefore the processing steps increases in number, leading to increased costs. Furthermore, due to the presence of the surface active agent, the polyurethane film having become a coating film declines in water resistance, so that, in the dyeing of the sheet-shaped article to which polyurethane has been imparted, the polyurethane tends to fall off into the dyeing solution.

The concentration of the water dispersed-type polyurethane liquid (in other words, the content of the polyurethane relative to the water-dispersed-type polyurethane liquid) is preferred to be greater than or equal to 10 mas % and less than or equal to 65 mas %, and more preferred to be greater than or equal to 10 mas % and less than or equal to 50 mas %.

In an embodiment of the invention, the fibrous base material is caused to contain the water dispersed-type polyurethane by coagulating the water dispersed-type polyurethane liquid after imparting it to the fibrous base material; however, because it is preferable to cause polyurethane to be contained uniformly in the thickness direction of the fibrous base material, the water dispersed-type polyurethane liquid is preferred to exhibit thermal coagulability. The water dispersed-type polyurethane liquid, in the case where it does not exhibit thermal coagulability, undergoes a migration phenomenon of concentrating to a surface layer of the fibrous base material at the time of dry coagulation, and the texture of the polyurethane-imparted sheet-shaped article tends to harden. Thermal coagulability refers to a property that when the water-dispersed-type polyurethane liquid is heated, the polyurethane liquid declines in fluidity and coagulates if a certain temperature (sometimes termed thermal coagulation temperature) is reached.

The thermal coagulation temperature is preferred to be greater than or equal to 40° C. and less than or equal to 90° C. By having the thermal coagulation temperature greater than or equal to 40° C., the stability of the water dispersed-type polyurethane liquid during storage is made good, and adhesion of the water dispersed-type polyurethane liquid to a machine during operation can be restrained. Furthermore, by having the thermal coagulation temperature less than or equal to 90° C., the migration phenomenon of the water dispersed-type polyurethane in the fibrous base material can be restrained. The thermal coagulation temperature is more preferably greater than or equal to 50° C. and less than or equal to 80° C., and particularly preferably greater than or equal to 55° C. and less than or equal to 80° C.

In order to make the thermal coagulation temperature as stated above, a thermal coagulation agent may be added as appropriate. As the thermal coagulation agent, there can be cited, for example, inorganic salts, including sodium sulfate, magnesium sulfate, calcium sulfate, calcium chloride, etc., and radical reaction initiation agents, including sodium persulfate, potassium persulfate, ammonium persulfate, azobisisobutyronitrile, benzoyl peroxide, etc.

The substance whose molecular weight is 100 to 500 and which has an amide bond in the invention is a decomposition product of a foaming agent in the manufacture method for the sheet-shaped article described below; for example, decomposition products of organic water-soluble foaming agents, such as 2,2′-azobis[2-methyl-N-(2-hydroxyethyl)propionamide] (for example, “VA-086” made by Wako Pure Chemical Industries, Ltd.), 2,2′-azobis{2-methyl-N-[1,1-bis(hydroxymethyl)-2-hydroxyethyl]propionamide)} (for example, “VA-080” made by Wako Pure Chemical Industries, Ltd.), etc., are cited.

In the invention, the water dispersed-type polyurethane's containing a substance whose molecular weight is 100 to 500 and which has an amide bond, that is, a decomposition product of a foaming agent, indicates that the water dispersed-type polyurethane has expanded due to the gas produced due to decomposition of the foaming agent. Furthermore, if the molecular weight of the substance that has an amide bond is excessively low, the substance gasifies due to the heating at the time of foaming, and therefore there exist issues regarding foul smell and the safety of an operating person during processes and also outflow into the environment, etc. If the molecular weight thereof is excessively high, the proportion of the amount of production of gas relative to the mass of what is added to the water dispersed-type polyurethane is small, and the foaming effect becomes low. Therefore, the molecular weight of the substance that is a decomposition product of a foaming agent is preferably 150 to 450.

The water dispersed-type polyurethane liquid for use in an embodiment of the invention contains a foaming agent and an inorganic particle. The foaming agent refers to an additive agent that, when heated, undergoes a chemical reaction, such as decomposition, and produces nitrogen gas or the like. Because of employment of a polyurethane liquid containing a foaming agent and an inorganic particle, when heating is performed after the polyurethane liquid is imparted to the fibrous base material, the foaming agent decomposes, and then the produced gas is in a fractionalized state where the gas is adsorbed to the inorganic particle, during which state the water dispersed-state polyurethane coagulates, so that the water dispersed-type polyurethane forms a porous structure.

As stated above, the water dispersed-type polyurethane for use in the invention is preferably a hard polyurethane of which the 100% modulus of a dry film is preferably greater than or equal to 3 MPa and less than or equal to 8 MPa. However, since the water dispersed-type polyurethane is caused to have a porous structure, the texture of the polyurethane-imparted sheet-shaped article becomes soft. This is because the adhered area between the fiber and the polyurethane within the polyurethane-imparted sheet-shaped article is reduced, so that the restraining force of the fiber is weakened.

Furthermore, since the hard polyurethane has a porous structure within the polyurethane-imparted sheet-shaped article, it is possible to obtain a graceful external appearance having a nap due to a nap raising step. As for formation of a graceful nap, it is advantageous that the polyurethane can be selectively ground more than the fiber in the nap raising step. Here, as for polyurethane, harder polyurethane is easier to grind; however, in the case where a hard polyurethane is employed, the texture of the polyurethane-imparted sheet-shaped article becomes hard so as to be unable to stand practical use. Therefore, a hard polyurethane is employed, and is made to have a porous structure, so that while the grindability of the polyurethane is good, the texture of the polyurethane-imparted sheet-shaped article is made soft.

As for the sheet-shaped article to which the water dispersed-type polyurethane liquid has been imparted, the timing of the heating for causing the foaming agent to foam may be either when or after the polyurethane coagulates. Furthermore, the porous structure may be either communicating pores or independent bubbles.

As the foaming agent contained in the water dispersed-type polyurethane liquid, azo compounds, including azobisformamide, azodicarbonamide, barium azodicarboxylate, 2,2′-azobisisobutyronitrile (this is sometimes abbreviated as AIBN), diazobenzene, diazoaminobenzene, azohexahydrobenzodinitrile, 2,2′-azobis-(2,4-dimethylvaleronitrile) (this is sometimes abbreviated as AVN), 1,1′-azobis(cyclohexane-1-carbodinitrile) (this is sometimes abbreviated as ACCN), 2,2′-azobis[2-(2-imidazoline-2-yl)propane], 2,2′-azobis{2-[1-(2-hydroxylethyl)-2-imidazoline-2-yl]propane}, 2,2′-azobis[N-(2-carboxyethyl)-2-methylpropionamidine], 2,2′-azobis(1-imino-1-pyrrolidino-2-methylpropane), 2,2′-azobis[2-methyl-N(2-hydroxyethyl)propionamide], etc. can be employed. These, for the purpose of improving the solubility in water, can be used in the form of a salt with an inorganic acid, such as hydrochloric acid or sulfuric acid, or is also allowed to be used in the form of a hydrate.

The content of the forming agent contained in the water dispersed-type polyurethane liquid is preferred to be greater than or equal to 0.5 mas % and less than or equal to 20 mas % in the ratio to the polyurethane solid content. If the content of the foaming agent is excessively small, the foaming becomes insufficient, and the texture of the sheet-shaped article becomes hard. If the content thereof is excessively large, the abrasion resistance of the sheet-shaped article declines. Therefore, the content of the foaming agent is more preferably greater than or equal to 1 mas % and less than or equal to 15 mas %.

The foaming agent is a compound that decomposes by heat and produces gas, and the 10-hour half-life temperature thereof is preferred to be 30° C. to 110° C. Taking into account the thermal coagulation temperature of the polyurethane, the 10-hour half-life temperature thereof is more preferably 40° C. to 100° C. If the 10-hour half-life temperature of the foaming agent is lower than 30° C., the progress of the decomposition is relatively fast even at room temperature, so that the concentration of the undecomposed foaming agent in the prepared solution decreases every moment. Therefore, there is a need to store the prepared solution at low temperature or a need to increase the frequency of preparing the solution. Furthermore, if the 10-hour half-life temperature of the foaming agent is higher than 110° C., there is a need to add a large amount of the foaming agent in order to produce an amount of gas that is needed in order to cause the polyurethane to have a porous structure, or there is a need to perform a heating process at high temperature or a heating process for a long time, which not only could bring about degradation of the polyurethane due to thermal decomposition or the like but also becomes a disadvantage in terms of production cost.

As the inorganic particle contained in the water dispersed-type polyurethane liquid, there are carbonaceous particles (activated carbon particles, carbon particles, etc.), metal silicate particles (calcium silicate particles), aluminum silicate particles, magnesium silicate particles, alumino-magnesium silicate particles, etc.), mineral particles (zeolite, diatomaceous earth, calcined diatomaceous, talc, kaolin, sericite, bentonite, smectite, clay, etc.), metal carbonate particles (magnesium carbonate particles, calcium carbonate particles, etc.), metal oxide particles (alumina particles, silica particles, zinc oxide particles, titanium dioxide particles, etc.), metal hydroxide particles (aluminum hydroxide particles, calcium hydroxide particles, magnesium hydroxide particles, etc.), metal sulfate particles (calcium sulfate particles, barium sulfate particles, etc.), metal nitride particles (silicon nitride particles, etc.), metal phosphate particles (calcium phosphate particles), etc. These porous particles can be used singly or in a combination of two or more kinds. Of these inorganic particles, porous inorganic particles are preferably used in view of adsorptive property, and metal oxide particles, such as silica and alumina, and metal phosphate particles, such as calcium phosphate, are more preferably used in view of surface hydrophilicity, and silica and aluminum are particularly preferably used in view of cost and availability.

The BET specific surface area of the aforementioned inorganic particle is preferably greater than or equal to 5 m²/g, and more preferably greater than or equal to 20 m²/g, and even more preferably greater than or equal to 50 m²/g. If the BET specific surface area thereof is smaller than 5 m²/g, there is exhibited a tendency that the gas produced from the foaming agent cannot be retained and it becomes difficult to make the polyurethane have a porous structure. The upper limit value of the BET specific surface area is assumed to be about 1,000 m²/g. If the upper limit value is excessively large, there is sometimes exhibited a tendency that the release of the gas trapped in small pores is affected and it becomes difficult to make the polyurethane have a porous structure.

The average particle size of the aforementioned inorganic particle is greater than or equal to 1 nm, and preferably greater than or equal to 6 nm, and more preferably greater than or equal to 10 nm. Furthermore, the upper limit value of the average particle size of the inorganic particle is 10,000 nm, and preferably 8,000 nm, and more preferably 6,000 nm. If the average particle size is smaller than 1 nm, the gas produced from the foaming agent cannot be retained, and the effect of addition of the inorganic particle cannot be sufficiently obtained. If the average particle size is larger than 10,000 nm, it becomes difficult to uniformly disperse the inorganic particle in the liquid.

The content of the inorganic particle contained in the water dispersed-type polyurethane liquid is preferred to be greater than or equal to 0.1 mas % and less than or equal to 20 mas % relative to the solid content of the polyurethane resin composition excluding the inorganic particle. If the content of the inorganic particle is excessively small, the foaming is insufficient, and the texture of the sheet-shaped article becomes hard. If the content thereof is excessively large, inorganic particles contained within the coagulated polyurethane interrupt the polyurethane film, causing a decline in strength. Therefore, the content of the inorganic particle is preferably greater than or equal to 1.0 mas % and less than or equal to 15 mas %, and more preferably greater than or equal to 1.5 mas % and less than or equal to 7.5 mas %.

The film density of the dry film of the water dispersed-type polyurethane liquid that contains the foaming agent and the inorganic particle used in the invention is preferred to be 0.1 to 0.8 and more preferably 0.1 to 0.5 as a ratio of the density of the porous film to the density of an nonporous film obtained by a heating process of a polyurethane liquid that does not contain a foaming agent. The film density is adjusted by the content of the foaming agent contained in the water dispersed-type polyurethane liquid described above.

The water dispersed-type polyurethane liquid may contain various kinds of additives, for example, pigments, including carbon black, etc., flame retardants, including phosphorus-based, halogen-based, silicone-based, inorganic flame and other flame retardants, antioxidants, including phenol-based, sulfur-based, phosphorus-based and other antioxidants, ultraviolet absorbers, including benzotriazole-based, benzophenone-based, salicylate-based, cyanoacrylate-based, oxalic acid anilide-based and other ultraviolet absorbers, light stabilizers, including hindered amine-based, benzoate-based and other light stabilizers, hydrolysis-proof stabilizers, including polycarbodiimide, etc., plasticizers, antistatic agents, surface active agents, softening agents, water repellents, coagulation modifiers, dyes, antiseptics, antimicrobial agents, deodorizers, fillers such as cellulose particles, etc.

The water dispersed-type polyurethane liquid may contain 40 mas % or less of a water-soluble organic solvent relative to the water dispersed-type polyurethane liquid in order to improve storage stability and film forming property. However, in view of conservation of the film forming environment and the like, the content of the organic solvent is preferred to be less than or equal to 1 mas %.

Through the impregnation, coating or the like of the fibrous base material with the water dispersed-type polyurethane liquid and through dry heat coagulation, wet heat coagulation or wet coagulation, or a combination of two or more of these, the polyurethane can be coagulated.

It suffices that the temperature of the wet heat coagulation is greater than or equal to the thermal coagulation temperature of the polyurethane; for example, the temperature thereof is preferred to be greater than or equal to 40° C. and less than or equal to 200° C. By setting the temperature of the wet heat coagulation to 40° C. or higher, and more preferably 80° C. or higher, the time up to the coagulation of the polyurethane can be shortened and the migration phenomenon can be more restrained. On the other hand, by setting the temperature of the wet heat coagulation to 200° C. or lower, and more preferably 160° C. or lower, thermal degradation of the polyurethane can be prevented.

It suffices that the temperature of the wet coagulation is greater than or equal to the thermal coagulation temperature of the polyurethane; for example, the temperature thereof is preferred to be greater than or equal to 40° C. and less than or equal to 100° C. By setting the temperature of the wet coagulation in hot water to 40° C. or higher, and more preferably 80° C. or higher, the time up to the coagulation of the polyurethane can be shortened, and the migration phenomenon can be more restrained.

The dry coagulation temperature and the drying temperature are preferred to be greater than or equal to 80° C. and less than or equal to 160° C. By setting the dry coagulation temperature and the drying temperature to 80° C. or higher, and more preferably 90° C. or higher, productivity will be excellent. On the other hand, by setting the dry coagulation temperature and the drying temperature to 180° C. or lower, and more preferably 160° C. or lower, thermal degradation of the polyurethane can be prevented.

The ratio of the water-dispersed-type polyurethane to the sheet-shaped article obtained by the invention is preferred to be 10 to 80 mas %. By setting the ratio of the water dispersed-type polyurethane to 10 mas % or greater, and more preferably 15 mas % or greater, a sheet strength can be obtained and fiber can be prevented from falling apart. Furthermore, setting the water dispersed-type polyurethane to 80 mas % or less, and more preferably 70 mas % or less, the texture can be prevented from becoming hard, and good nap quality can be obtained.

After impartment of the water dispersed-type polyurethane, division of the polyurethane-imparted sheet-shaped article into halves or a few sheets in the sheet thickness direction provides excellence in production efficiency, and is a preferred mode.

Prior to the nap raising process described below, a lubricant, such as a silicone emulsion, may be imparted to the polyurethane-imparted sheet-shaped article. Furthermore, imparting an antistatic agent prior to the nap raising process is a preferred mode in terms of making it less likely that ground powder produced from the sheet-shaped article by grinding will deposit on the sandpaper.

In order to form a nap on a surface of the sheet-shaped article, the nap raising process may be performed. The nap raising process can be performed by a method in which the grinding is carried out by employing a sandpaper, a roll sander, etc.

The thickness of the sheet-shaped article is preferred to be 0.1 to 5 mm because if the thickness is excessively small, physical characteristics of the sheet-shaped article, such as tensile strength or tear strength, become weak, and if the thickness is excessively great, the texture of the sheet-shaped article becomes hard.

The sheet-shaped article may be dyed. As for a dyeing method, it is preferable to employ a jet dyeing machine because the machine is capable of dyeing the sheet-shaped article and, simultaneously, softening the sheet-shaped article by giving it a kneading effect.

If the dyeing temperature is excessively high, the polyurethane sometimes degrades. Conversely, if the temperature is excessively low, the dye attachment to the fiber becomes insufficient. Therefore, it is appropriate to set the dyeing temperature depending on the kinds of fiber. Generally, the dyeing temperature is preferred to be greater than or equal to 80° C. and less than or equal to 150° C., and more preferably greater than or equal to 110° C. and less than or equal to 130° C.

It suffices that the dye is selected in accordance with the kind of the fiber that constitutes the fibrous base material. For example, if the fiber is a polyester-based fiber, a dispersed dye can be employed. If the fiber is a polyamide-based fiber, an acidic dye or a metal-containing dye can be used. Moreover, combinations of such dyes can be employed. In the case where the dyeing is carried out with a dispersed dye, reduction cleaning may be performed after the dyeing.

Furthermore, using a dyeing assistant at the time of dyeing is also a preferred mode. By using a dyeing assistant, the uniformity and reproducibility of dyeing can be improved. Furthermore, in the same bath as the dyeing or after the dyeing, a finishing agent process that employs a softening agent, such as silicone or the like, an antistatic agent, a water repellent, a flame retardant, a light resistance agent, an antimicrobial agent, etc. can be carried out.

The sheet-shaped article obtained through the invention can be suitably used as interior materials that have very graceful external appearances as skin materials for furniture, chairs and wall materials, and also seats, ceilings, interiors, etc. in vehicle compartments of motor vehicles, trains and aircrafts, and used as clothing materials for shirts, jackets, the uppers, trims, etc. of casual shoes, sports shoes, men's shoes, women's shoes, etc., bags, belts, wallets, etc., or parts of such items, and as industrial-use materials, such as wiping clothes, grinding clothes, compact-disk curtains, etc.

### EXAMPLES

Next, the sheet-shaped article and the manufacture method for the sheet-shaped article of the invention will be further described in detail with reference to examples; however, the invention is not limited only to these examples.

[Evaluation Methods]

(1) Average Filament Diameter:

The average filament diameter was worked out by taking scanning type electron microscope (SEM) photographs of thickness-direction sections of fibrous base materials or sheet-shaped articles at a magnification of 2000 times, randomly selecting 100 filaments having a circular shape or an elliptic shape close to a circular shape, measuring the filament diameters thereof, and calculating an average value thereof.

In the case where the ultrathin fiber that constitutes a fibrous base material or a sheet-shaped article has a section of a less common shape, the diameter of an outside peripheral circle of the less common-shaped section is worked out as a filament diameter. Furthermore, in the case where a circular section and a less common-shaped section are mixed, the case where filaments having greatly different filament diameters are mixed, etc., 100 filaments are selected so that the numbers of such types of filaments are about equal.

(2) Film Density of Dry Film of Water Dispersed-Type Polyurethane Liquid:

20 ml of a 20-mas % polyurethane aqueous dispersion liquid containing a foaming agent and an inorganic particle was placed in a 5 cm×10 cm×1 cm tray made of polyethylene, and was subjected to a heat process for 2 hours by a hot air dryer set to a temperature of 120° C., to obtain a polyurethane dry film. Scanning type electron microscope (SEM) photographs of a thickness-direction section of the obtained polyurethane dry film were taken at a magnification of 50 times, and the thickness in the thickness direction at 10 arbitrary points, and an average value thereof was determined as an average thickness of the polyurethane dry film. The weight of the polyurethane dry film measured by an electrobalance was divided by the volume to obtain a density of the polyurethane dry film.

(3) Analysis of Substance with an Amide Bond Contained in Polyurethane Dry Film:

The polyurethane dry film indicated in the previous paragraph was segmented into about 1 cm squares, which were dipped into a 50 ml of N,N-dimethylformamide poured in an Erlenmeyer flask, and was subjected together with the Erlenmeyer flask to an extraction process for 30 minutes by an ultrasonic cleaner. The extract liquid was analyzed by using a liquid chromatograph mass spectrometer (LC-MS) (made by Shimadzu Corporation, Ultrafast Single Quadrupole Type Mass Spectrometer LCMS-2020) to identify a substance having an amide bond. The molecular weight thereof was derived from the mass spectrum.

(4) Thermal Coagulation Temperature of Water Dispersed-Type Polyurethane Liquid:

20 ml of a water dispersed-type polyurethane liquid prepared so that the solid content of polyurethane was 10 mas % was added into a test tube whose inside diameter was 12 mm. After a thermometer was inserted thereinto, the test tube was sealed, and dipped into a hot water bath having a temperature of 95° C. The temperature of the prepared liquid at which the liquid lost its fluidity as the temperature increased was measured as a thermal coagulation temperature.

(5) Texture of Sheet-Shaped Article:

As for the texture of each sheet-shaped article, 5 test pieces of 2×15 cm in the longitudinal direction and the lateral direction, respectively, were made, and were each placed on a horizontal table having a slope whose angle was 45°, and then slid. The scale when a central point at an end of a test piece contacted the slope was read, and an average of the 5 pieces was found, on the basis of an A method (45° cantilever method) mentioned in JIS L1096-8.19.1 (1999). The texture was determined as being good if the average value was less than or equal to 50 mm.

(6) External Appearance Quality of Sheet-Shaped Article

The external appearance quality of each sheet-shaped article was rated on a scale of 1 to 5 in visual inspection and sensory evaluation by a total of 20 raters made up of 10 males and 10 females who were both healthy adults. The rating given by the greatest number of raters was determined as an external appearance quality. As for the external appearance quality, Grade 3 to Grade 5 were determined as being good.
Grade 5: Uniformly raised fibers exist, and the dispersed state of fiber is good, and the external appearance is good.
Grade 4: Rating between Grade 5 and Grade 3.
Grade 3: The dispersed state of fiber is partially not very good, raised fibers exist, and the external appearance is fairly good.
Grade 2: Rating between Grade 3 and Grade 1.
Grade 1: The dispersed state of fiber is very bad as a whole, and the external appearance is rejected.

[Preparation of Polyurethane Liquid A]

3 mass parts of “VA-086” (made by Wako Pure Chemical Industries, Ltd., 2,2′-azobis[2-methyl-N-(2-hydroxyethyl)propionamide]) was added as a foaming agent to 100 mass parts in solid content of a polyoxyethylene chain-containing polycarbonate-based self-emulsified polyurethane (thermal coagulation temperature: 74° C.) liquid that used polyhexamethylene carbonate as the polyol and dicyclohexylmethane diisocyanate as the isocyanate, as a water dispersed-type polyurethane. Furthermore, as an inorganic particle, “Brian (registered trademark) SL-100N” (made by Matsumoto Yushi-Seiyaku Co., Ltd., an aqueous dispersion liquid of porous silica with the BET specific surface area of silica being 350 m²/g and the average particle size of silica being 100 nm) was added so that the amount of silica was 3 mass parts. The dispersion was prepared with water so that the total solid content was 20 mas %, which was named polyurethane liquid A.

[Preparation of Polyurethane Liquid B]

A polyurethane liquid was prepared in substantially the same manner as the polyurethane liquid A, except that, instead of “VA-086” (made by Wako Pure Chemical Industries, Ltd., 2,2′-azobis[2-methyl-N-(2-hydroxyethyl)propionamide]) as the foaming agent in the preparation of the polyurethane liquid A, 3 mass parts of “V-50” (made by Wako Pure Chemical Industries, Ltd., 2,2′-azobis(2-methylpropionamide)dihydrochloride)) was added. This liquid was named polyurethane liquid B.

[Preparation of Polyurethane Liquid C]

A polyurethane liquid was prepared in substantially the same manner as the polyurethane liquid A, except that, instead of the porous silica in the preparation of the polyurethane liquid A, 3 mass parts of “TAIMICRON (registered trademark) TM-50” (made by TAIMEI CHEMICALS Co., Ltd., alumina with the BET specific surface area being 9.0 m²/g and the average particle size being 14 rim) was added. This liquid was named polyurethane liquid C.

[Preparation of Polyurethane Liquid D]

A polyurethane liquid was prepared in substantially the same manner as the polyurethane liquid A, except that, in the preparation of the polyurethane liquid A, no porous silica was added. This liquid was named polyurethane liquid D.

[Preparation of Polyurethane Liquid E]

A polyurethane liquid was prepared in substantially the same manner as the polyurethane liquid A, except that, instead of the porous silica in the preparation of the polyurethane liquid A, 3 mass parts of “Dow Corning (registered trademark) EP-9215” (made by Dow Corning Toray Co., Ltd., an silicone elastomer with the BET specific surface area being 1.5 m²/g and the average particle size being 4μm) was added. This liquid was named polyurethane liquid E.

[Preparation of Polyurethane Liquid F]

A polyurethane liquid was prepared in substantially the same manner as the polyurethane liquid A, except that in the porous silica having an average particle size of 100 nm in the preparation of the polyurethane liquid A, 3 mass parts of “DAISOGEL (registered trademark) IR-60-25/40-W” (made by DAISO Co., Ltd., a pulverized silica gel with the average particle size being 30 μm) was added. This liquid was named polyurethane liquid F.

[Preparation of Polyurethane Liquid G]

A polyurethane liquid was prepared in substantially the same manner as the polyurethane liquid A, except that in the preparation of the polyurethane liquid A, no foaming agent was added. This liquid was named polyurethane liquid G.

The compositions and properties of the polyurethane liquids A to G prepared as mentioned above are collectively shown in Table 1.

### [Table 1]

TABLE 1

| | | | Particle | | | | Molecular | Thermal |
|---|---|---|---|---|---|---|---|---|
| | | | | BET | Average | Film | weight of | coagulation |
| | Polyurethane | Foaming | | specific | particle | density | substance with | temperature |
| | liquid | agent | Kind | area (m²/g) | size (μm) | (g/cm³) | amide bond | (° C.) |
| Example 1 | A | VA-086 | Porous silica | 350 | 0.1 | 0.22 | 131, 199 | 74 |
| Example 2 | B | V-50 | Porous silica | 350 | 0.1 | 0.34 | 170 | 74 |
| Example 3 | A | VA-086 | Porous silica | 350 | 0.1 | 0.22 | 131, 199 | 74 |
| Example 4 | C | VA-086 | Alumina | 9 | 0.014 | 0.28 | 131, 199 | 74 |
| Comparative Example 1 | D | VA-086 | — | — | — | 0.76 | 131, 199 | 74 |
| Comparative Example 2 | E | VA-086 | Silicone | 1.5 | 4 | 0.81 | 131, 199 | 74 |
| | | | elastomer | | | | | |
| Comparative Example 3 | F | VA-086 | Silica gel | 300 | 30 | 0.66 | 131, 199 | 74 |
| Comparative Example 4 | G | — | Porous silica | 350 | 0.1 | 0.96 | — | 74 |

### Example 1

The density of a polyurethane film A obtained from the polyurethane liquid A was 0.22 g/cm³. Furthermore, from the polyurethane film A, substances having an amide bond was detected. The molecular weights of the substances were 131 and 199.

Next, using, as a sea component, polyethylene terephthalate obtained by copolymerizing 8 mol % of sodium 5-sulfoisophthalate and using polyethylene terephthalate as an island component, a sea-island conjugate fiber of which the composite ratio was 45 mas % of the sea component and 55 mas % of the island component, the number of islands was 36 islands/1 filament, and the average filament diameter was 17 μm was obtained. The obtained sea-island conjugate fiber was cut into pieces of a fiber length of 51 mm, which were used as staples and passed through a card and a cross lapper, to form a fiber web, which was subjected to a needle punch process to obtain a non-woven fabric.

The non-woven fabric obtained in this manner was shrunk by dipping it into a hot water at a temperature of 98° C. for 2 minutes, and then was dried at a temperature of 100° C. for 5 minutes. Next, the obtained non-woven fabric was impregnated with the polyurethane liquid A prepared as mentioned above, and was treated for 5 minutes in a wet hot atmosphere at a temperature of 97° C. and a humidity of 100%, and was dried by hot air for 5 minutes at a drying temperature of 120° C. in temperature, and then was subjected to a dry heat process for 2 minutes at a temperature of 150° C., to obtain a sheet provided with polyurethane so that the mass of polyurethane relative to the mass of the island component of the non-woven fabric was 30 mas %.

Next, this sheet was dipped into a sodium hydroxide aqueous solution having a concentration of 10 g/L and having been heated to 95° C., and was treated for 30 minutes. Thus, a sea-removed sheet with the sea component removed from the sea-island fiber was obtained. The average filament diameter of the sea-removed sheet surface was 2 μm. Then, the surface of the sea-remove sheet was subjected to a nap raising process on both sides by grinding the surfaces through the use of a 240-mesh endless sandpaper, and then was dyed by a dispersed dye through the use of a circular dyeing machine. Then, reduction cleaning was performed to obtain a sheet-shaped article A. The external appearance quality, the texture and the abrasion resistance of the obtained sheet-shaped article were good.

### Example 2

A polyurethane film B and a sheet-shaped article B were obtained in substantially the same manner as in Example 1, except that the polyurethane liquid in Example 1 was changed to the polyurethane liquid B shown in Table 1. In Example 2, which employed the polyurethane liquid B, the density of the polyurethane film B obtained was 0.34 g/cm³. Furthermore, from the polyurethane film B, a substance having an amide bond was detected. The molecular weight of the substance was 170. The external appearance quality, the texture and the abrasion resistance of the obtained sheet-shaped article B were good.

### Example 3

A sheet-shaped article A-2 was obtained in substantially the same manner as in Example 1, except that, using, as a sea component, polyethylene terephthalate obtained by copolymerizing 8 mol % of sodium 5-sulfoisophthalate and using 66-nylon as an island component in Example 1, a sea-island conjugate fiber of which the composite ratio was 60 mas % of the sea component and 40 mas % of the island component, the number of islands was 100 islands/1 filament, and the average filament diameter was 22 μm was obtained. The average filament diameter at a sea-removed sheet surface was 1.4 μm. The external appearance quality, the texture and the abrasion resistance of the obtained sheet-shaped article were good.

### Example 4

A polyurethane film C and a sheet-shaped article C were obtained in substantially the same manner as in Example 1, except that the polyurethane liquid in Example 1 was changed to the polyurethane liquid C shown in Table 1. In Example 4, which employed the polyurethane liquid C, the density of the polyurethane film C obtained was 0.28 g/cm³. Furthermore, from the polyurethane film C, substances having an amide bond were detected. The molecular weights of the substances were 131 and 199. The external appearance quality, the texture and the abrasion resistance of the sheet-shaped article C obtained were good.

### Comparative Examples 1 to 4

Polyurethane films D to G and sheet-shaped articles D to G were obtained in substantially the same manner as in Example 1, except that the polyurethane liquid in Example 1 was changed to the polyurethane liquids D to G shown in Table 1.

In Comparative Example 1, which employed the polyurethane liquid D, because an inorganic particle was not added, the density of the polyurethane film D obtained was 0.76 g/cm³. Furthermore, from the polyurethane film D, substances having an amide bond was detected. The molecular weights of the substances were 131 and 199. In the sheet-shaped article D obtained, the polyurethane filling the inside did not have a porous structure, and the grindability in the nap raising step became low, so that the external appearance quality became rejected and the texture was hard.

In Comparative Example 2, which employed the polyurethane liquid E, because an organic particle that was not porous was added, the density of the polyurethane film E obtained was 0.81 g/cm3. Furthermore, from the polyurethane film E, substances having an amide bond were detected. The molecular weights of the substances were 131 and 199. In the sheet-shaped article E obtained, the polyurethane filling the inside did not have a porous structure, and the grindability in the nap raising process became low, so that the external appearance quality became rejected and the texture was hard.

In Comparative Example 3, which employed the polyurethane liquid F, because a silica gel whose average particle size was 30 μm was added, the density of the polyurethane film F obtained was 0.66 g/cm³. Furthermore, from the polyurethane film F, substances having an amide bond were detected. The molecular weights of the substances were 131 and 199. A section of the obtained sheet-shaped article F in the thickness direction was observed under an SEM. Uneven distribution of silica gel particles to the vicinity of a side surface was recognized, making a sheet that had different external appearance qualities on the obverse and reverse surfaces, with both surfaces being rejected in external appearance quality.

In Comparative Example 4, which employed the polyurethane liquid G, because a foaming agent was not added, the density of the polyurethane film G obtained was 0.96 g/cm³. Furthermore, from the polyurethane film G, a substance having an amide bond was not detected. In the obtained sheet-shaped article G, the polyurethane filling the inside did not have a porous structure, and the grindability in the nap raising process became low, so that the external appearance quality became rejected and the texture was hard.

The aforementioned results are collectively shown in Table 2.

### [Table 2]

TABLE 2

| | | | | External |
|---|---|---|---|---|
| | Polyurethane | Sheet-shaped | Texture | appearance |
| | liquid | article | (mm) | quality (grade) |
| Example 1 | A | A | 30 | 5 |
| Example 2 | B | B | 45 | 5 |
| Example 3 | A | A-2 | 28 | 5 |
| Example 4 | C | C | 38 | 5 |
| Comparative | D | D | 140 | 1 |
| Example 1 | | | | |
| Comparative | E | E | 100 | 2 |
| Example 2 | | | | |
| Comparative | F | F | 90 | 2 |
| Example 3 | | | | |
| Comparative | G | G | 150 | 1 |
| Example 4 | | | | |

1. A sheet-shaped article containing a water dispersed-type polyurethane that contains both a substance whose molecular weight is 100 to 500 and which has an amide bond and an inorganic particle whose average particle size is 1 nm to 10,000 nm, within a fibrous base material that includes an ultrathin fiber whose average monofilament diameter is 0.3 to 7 μm.

2. The sheet-shape article according to claim 1, wherein the inorganic particle is a porous particle whose BET specific surface area is greater than or equal to 5 m²/g.

3. The sheet-shaped article according to claim 1, wherein the inorganic particle is of silica.

4. A manufacture method for a sheet-shaped article comprising imparting to a fibrous base material a water dispersed-type polyurethane liquid that contains both a foaming agent and an inorganic particle and performing a heating process at a temperature that is greater than or equal to a temperature at which at least a portion of the foaming agent reacts and produces a gas.

5. The manufacture method for the sheet-shaped article according to claim 4, wherein the foaming agent is a water-soluble azo polymerization initiating agent.

6. The manufacture method for the sheet-shaped article according to claim 5, wherein the inorganic particle is of silica.

7. The manufacture method for the sheet-shaped article according to claim 4, wherein the fibrous base material includes an ultrathin fiber development type fiber.

8. The manufacture method for the sheet-shaped article according to claim 6, further comprising developing from the ultrathin fiber development type fiber an ultrathin fiber whose average monofilament diameter is 0.3 to 7 μm.
